(19) United States
(12) Patent Application Publication
(10) Pub. No.: US 2012/0294964 A1
(43) Pub. Date: Nov. 22, 2012

(54) DEVICE FOR STRETCHING AND/OR ALIGNING RAW DOUGH PRODUCTS, IN PARTICULAR, STRANDS OF DOUGH PRESHAPED TO PRODUCE PRETZELS

(76) Inventor: OSWALD PILLER, Karlsfeld (DE)

(21) Appl. No.: 13/472,809

(22) Filed: May 16, 2012

(30) Foreign Application Priority Data
May 16, 2011 (DE) 1020110503722

(51) Int. Cl. A21D 8/02

(52) U.S. Cl. 425/150

(57) ABSTRACT

An apparatus for stretching and/or aligning raw dough products, in particular, strands of dough pre-shaped to produce pretzels, comprises means for stretching and/or aligning the U-shaped raw dough products arriving with the branches of the U in front. The means for stretching and/or aligning the raw dough products are controlled by a control device that uses as input parameters the extent of the required alignment and/or the extent of the stretching of the raw dough product. This control device comprises a device for close-range photogrammetry, by means of which the exact position of the raw dough product is determined in a computer-assisted manner in an image produced by a digital camera. The raw dough product can be measured using the known removal of the device for close-range photogrammetry towards the raw dough product.

### BACKGROUND OF THE INVENTION

The present invention relates to a device for stretching and/or aligning raw dough products, in particular, strands of dough pre-shaped to produce pretzels.

Devices of the aforementioned type may be used, for example, in order transfer stretched and aligned strands of dough from a conveyor belt to a further processing station, for example to a loop-forming machine.

A device for transferring preshaped, elongate raw dough products of predetermined length is disclosed in DE 198 16 738 C2. This device comprises a single-part or multi-part receiver arrangement about an axis located parallel to the strand of dough, for transferring or selecting the raw dough product. The device is provided with a length measuring device with sensors for the raw dough product and a correction device for wave-shaped raised portions of the raw dough product.

This arrangement, however, is relatively expensive in production due to the many mechanical parts required. Moreover, due to the multi-part construction, this may lead to breakdowns more often than in a device which comprises fewer parts.

Apparatus for producing pretzels is disclosed in DE 198 07 692 C2. This device comprises a positioning device which includes a rotatable positioning wheel with a drive unit, a sensor device and a control unit, the positioning device being configured to be height-adjustable and or pivotable. By means of the positioning device, it is possible to align the strand of dough. Disadvantageously, however, raw dough products may not be stretched and/or smoothed using this device.

Apparatus for stretching and/or smoothing and/or aligning raw dough products is disclosed in DE 10 2006 051 300 B4, in particular, for strands of dough preshaped to produce pretzels, which comprises as a means for stretching and/or aligning the raw dough products two rotatable wheels that may be driven independently of one another and which may be arranged adjacent to one another perpendicular to the conveying direction of a chute or a conveyor belt. In this case it is provided that the arriving raw dough products are stretched and/or smoothed by means of a simultaneous rotary movement of the wheels in opposing directions, taking place by means of the signals of a control unit, and/or aligned by means of a simultaneous rotary movement of the wheels in the same direction taking place by means of the signals of a control unit.

The dimensioning of the wheels and the spacing of the wheels relative to one another are measured according to DE 10 2006 051 300 B4, such that the raw dough product is able to adopt a desired shape.

As a result, the apparatus of this type is able to be used both for stretching and/or smoothing and for aligning the raw dough products while having a very compact shape.

Further apparatus for stretching or smoothing and/or aligning raw dough products is disclosed in the German Application No. DE 10 2010 008 024.1 A1 of the present applicant. This apparatus comprises as means for stretching and/or aligning the raw dough products two rotatable wheels which may be driven independently of one another and which may be arranged adjacent to one another perpendicular to the conveying direction of a chute or a conveyor belt. The arriving raw dough products are stretched and/or smoothed by means of a simultaneous rotary movement of the wheels in opposing directions, controlled by means of the signals of a control unit or by means of a rotary movement of one of the wheels when the other wheel is fixedly braked or by means of a simultaneous rotary movement of the wheels in the same direction. In this apparatus, the spacing of the two wheels relative to one another is adjustable, viewed in the direction perpendicular to the conveying direction of the chute or the conveyor belt. Moreover, a sensor device is provided which comprises two sensors for detecting the ends of a strand of dough of the arriving raw dough products, the sensors viewed axially being arranged at a predetermined spacing from the wheels, in or counter to the conveying direction.

Such sensors are also utilized in the apparatus disclosed in the aforementioned DE 10 2006 051 300 B4.

Disadvantageously, the use of sensors increases the complexity of the system and the costs associated therewith. Moreover, it is not possible to predict by using the signals from the sensors whether the arriving raw dough product has to be stretched and, if so, to what extent.

The sensors known from the prior art of these types of devices are designed as light barriers.

Apparatus for positioning pretzels is also known from WO 2010/066227 A2. This apparatus comprises an industrial robot with a gripper configured for receiving one end of a strand of dough, the industrial robot alternately receiving and pivoting the branches of the strand of dough, so that a pretzel-shaped raw dough product is produced. In the known device a laser measuring system for determining the position and/or strand of the supplied straight strand of dough may be provided. In this case, according to the document WO 2010/066227, the use of such a measuring system is only required when greater position tolerances and strand tolerances are able to occur or when a high quality is intended to be achieved. In the event that a measuring system is provided, the straight strand of dough after detection of the length or position thereof is conveyed on the conveyor belt towards an arcuate wall of a shaping element provided and held thereby, whilst the lateral regions of the strand of dough are conveyed further, whereby the strand of dough adopts a U-shape.

### SUMMARY OF THE INVENTION

A principal object of the present invention is to provide apparatus for stretching and/or aligning raw dough products, in which a measurement of the amount of the required alignment and a determination of the required amount of stretching of the arriving U-shaped raw dough product is made possible in the most accurate manner possible.

This object, as well as other objects which will become apparent from the discussion that follows, are achieved, according to the present invention, by improving the known apparatus for stretching and/or aligning raw dough products, preferably strands of dough preshaped to produce pretzels, of the type which comprises means for stretching and/or aligning the U-shaped raw dough products arriving with the branches (legs) of the U in front, or forward direction, as they are moved on the conveyor. The means for stretching and/or aligning the raw dough products are controlled by a control device which uses as input parameters the extent of the required alignment and/or the extent of the stretching of the raw dough product. In addition to these parameters, further input parameters may also be used, such as for example the start time of the process for aligning and/or for stretching the raw dough products.

According to the invention, for determining the input parameters of the control device, the apparatus for stretching and/or aligning raw dough products comprises a device for close-range photogrammetry.

In this case, in a manner known from the prior art, by means of a device for photogrammetry, the exact position of the arriving raw dough product may be determined in a computer-assisted manner in an image produced by a digital camera. The raw dough product is also measured in a computer-assisted manner using the known removal of the device for close-range photogrammetry towards the raw dough product.

Alternatively to the device for close-range photogrammetry, for determining the input parameters of the control unit of the apparatus for stretching and/or aligning the raw dough products may be provided with a thermal imaging camera (thermographic camera), by means of which the arriving raw dough products being can be measured in a computer-assisted manner. The use of the thermal imaging camera also has the advantage that, at the same time as determining the input parameters, the temperature of the raw dough product is detected, whereby measures may be optionally introduced in order to increase or to reduce the temperature of the arriving raw dough products. In this manner, the dough can be prevented from becoming too warm, as this results in the raw dough products being able to tear easily when handled.

Preferably, the device for close-range photogrammetry or the thermal imaging camera are fixedly installed, and detect the arriving raw dough product whilst said raw dough product is supplied by means of a conveyor belt to the device for stretching and/or aligning.

By measuring of the arriving raw dough products according to the invention, the difference in length between the two branches of the raw dough product is determined, half thereof representing the extent of the alignment of the raw dough product and as an input parameter is forwarded to the control unit of the device for stretching and/or aligning.

Moreover, by the measurement of the arriving raw dough products using the detected overall length of the raw dough product and the deviation from the set length of the raw dough product it may be determined whether the dough is intended to be stretched and to what extent.

As, for example, the weight of a raw dough product is known with small tolerances, the set length may be determined or the value of the set length is stored in the control device of the device for stretching and/or aligning the raw dough products. The difference between the set length and the detected length (actual length) of the raw dough product is preferably determined as a measurement of the stretching of the raw dough product. Within the scope of a development of the invention, the detected length of the raw dough products may be transmitted to a dough shaping unit (a so-called strand forming unit) arranged upstream of the device for stretching and/or aligning, whereby the length of the raw dough products produced in the dough shaping unit may be adapted to the desired (set) length so that when the detected length is greater than the set length, shorter raw dough products may be produced in the dough shaping unit and vice versa.

Moreover, according to the invention, using the position of the raw dough product at the detection time as well as the known conveyor belt speed, the time may be determined at which the raw dough product comes into contact with the means for stretching and/or aligning, so that at this time the process for stretching and/or aligning begins immediately.

As means for stretching and/or aligning the raw dough products, any such means known from the prior art may be used. For example, means according to the aforementioned DE 10 2010 008 024.1 and/or DE 10 2006 051 300 B4 of the applicant may be used. The specification and drawings of these references are incorporated herein by reference in their entirety.

Accordingly, the means for stretching and/or aligning the raw dough products may be designed as two rotatable wheels which are able to be driven independently of one another and which may be arranged adjacent to one another perpendicular to the conveying direction of a chute or conveyor belt. In this case, it is provided that the arriving raw dough products are stretched and/or smoothed by means of a simultaneous rotary movement of the wheels in opposing directions taking place by means of the signals of a control unit, and/or aligned by means of a simultaneous rotary movement of the wheels in the same direction taking place by means of the signals of a control unit, the dimensioning of the wheels and the spacing of the wheels relative to one another being dimensioned such that the raw dough product is able to adopt a desired shape. The wheels are arranged above the chute and/or the upper run of the conveyor belt transporting the raw dough products and designed to be pivotable or/and able to be adjusted in the longitudinal direction thereof vertically to the plane of the chute and/or the conveyor belt, so that when the wheels are in a first end position, an arriving raw dough product is not able to come into contact with the wheels, in a second end position the arriving raw dough products coming into contact around the wheels.

The wheels for stretching and/or aligning the raw dough products may also be designed as two rotatable wheels which may be driven independently of one another and which may be arranged adjacent to one another perpendicular to the conveying direction of a chute or conveyor belt, the arriving raw dough products being able to be stretched and/or smoothed by means of a simultaneous rotary movement of the wheels in opposing directions taking place by means of the signals of a control unit or by means of a rotary movement of one of the wheels when the other wheel is fixedly braked, and/or aligned by means of a simultaneous rotary movement of the wheels in the same direction taking place by means of the signals of a control unit, the spacing of the two wheels of the device relative to one another being able to be adjusted, viewed in a direction perpendicular to the conveying direction of the chute or the conveyor belt.

In this case, the spacing of the two wheels of the device relative to one another, viewed in the direction perpendicular to the conveying direction of the chute or the conveyor belt, may be adjusted such that the wheels are arranged symmetrically to the longitudinal axis of the chute (the longitudinal axis is at the same time the axis of symmetry in the longitudinal direction) or of the conveyor belt.

Moreover, between the two wheels at least one freely rotatable or non-rotatable pin or journal may be provided which is arranged, viewed in the conveying direction of the chute or the conveyor belt, such that when the raw dough product comes into contact with the two wheels of the device and with the at least one pin or journal, the transverse part of the U-shape of the raw dough product which is present or is to be adopted, extends substantially perpendicular to the conveying direction of the chute or the conveyor belt.

The wheels and the at least one wheel or the at least one pin or journal are arranged above the chute and/or the upper run of the conveyor belt transporting the raw dough products, and designed to be pivotable or/and in the longitudinal direction thereof able to be adjusted vertically to the plane of the chute and/or the conveyor belt, so that when the wheels and the at least one wheel or the at least one pin or journal is located in a first end position, an arriving raw dough product is not able to come into contact with the wheels and the at least one wheel or the at least one pin or journal, in a second end position the arriving raw dough products coming into contact with the wheels and the at least one wheel or the at least one pin or journal.

### BRIEF DESCRIPTION OF THE DRAWINGS

FIG. 1 is a schematic illustration of apparatus for stretching and/or smoothing and/or aligning a raw dough strand, in particular, for making pretzels.

FIG. 2 is a representational diagram of a control device according to a first preferred embodiment of the present invention.

FIG. 3 is a representational diagram of a control device according to a second preferred embodiment of the present invention.

### DETAILED DESCRIPTION OF THE PREFERRED EMBODIMENTS

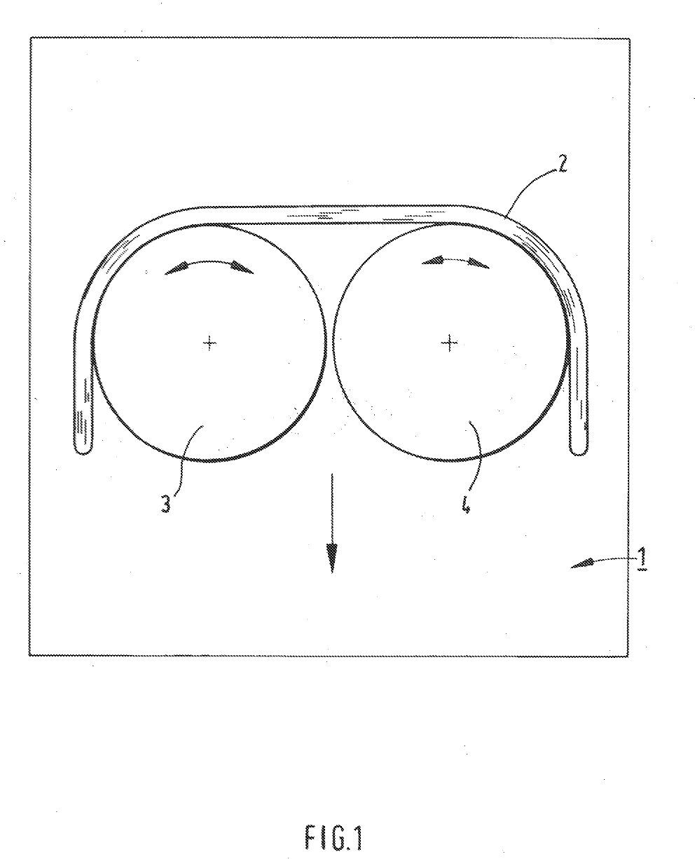

The preferred embodiments of the present invention will now be described with reference to FIGS. 1-3 of the drawings. Identical elements in the various figures are designated with the same reference numerals.

FIG. 1 illustrates one example of a device to which the present invention relates. This device, which is shown and described in detail in the aforementioned documents DE 10 2006 051 300 B4 and DE 110 2010 008 024.1 A1, comprises a conveyor belt 1 and two independently driven wheels 3 and 4 over which the raw dough product 2 is stretching and/or aligned.

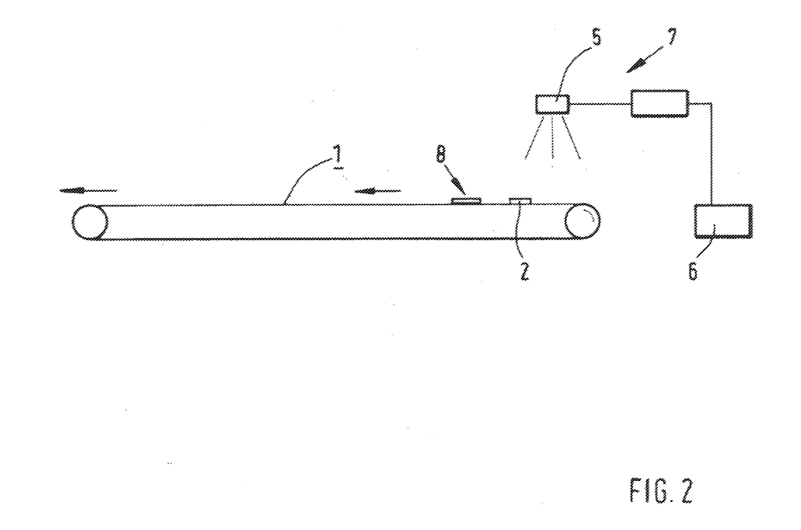

FIG. 2 shows the conveyor belt 1 which carries the raw dough product 2 and the device 8 for stretching and/or aligning. In this embodiment the control system incorporates a device 7 for photogrammetry having a digital camera 5 and a control unit 6.

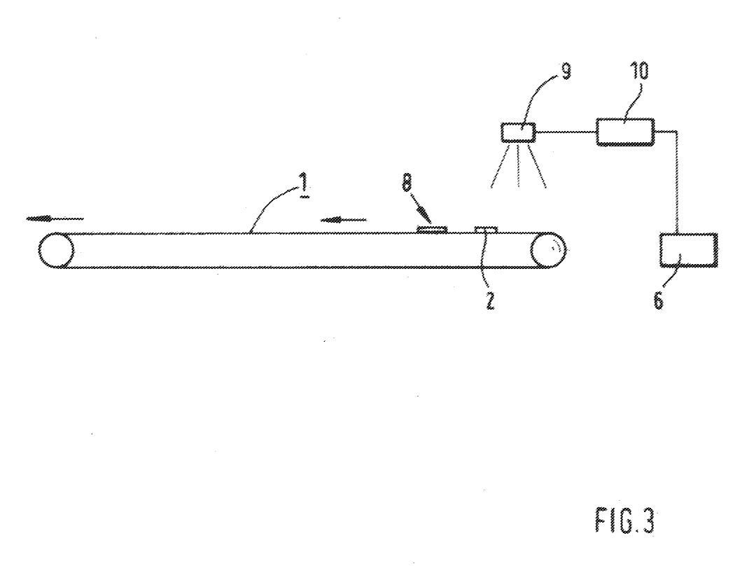

Similarly, FIG. 3 shows the conveyor belt 1 which carries the raw dough product 2 and the device 8 for stretching and/or aligning. In this embodiment the control system employs a thermal imaging camera, a control unit 6 and a device for determining the input parameters to the control unit.

There has thus been shown and described a novel device for stretching and/or aligning raw dough products, in particular, strands of dough pre-shaped to produce pretzels which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. In apparatus for stretching and/or aligning raw dough products, in particular, strands of dough preshaped to produce pretzels, comprising means for stretching and/or aligning the U-shaped raw dough products arriving with the branches of the U in front, said means for stretching and/or aligning the raw dough products being controlled by a control device that uses as input parameters at least one of the extent of the required alignment and the extent of the stretching of the raw dough product, the improvement wherein the input parameters for said control device are determined by a device for close-range photogrammetry, by means of which the exact position of the raw dough product is determined in a computer-assisted manner in an image produced by a digital camera, the raw dough product being measured using the known removal of the device for close-range photogrammetry towards the raw dough product.

2. In apparatus for stretching and/or aligning raw dough products, in particular, strands of dough pre-shaped to produce pretzels, comprising means for stretching and/or aligning the U-shaped raw dough products arriving with the branches of the U in front, said means for stretching and/or aligning the raw dough products being controlled by a control device that uses as input parameters at least one of the extent of the required alignment and the extent of the stretching of the raw dough product, the improvement wherein the input parameters for said control device are determined by a thermal imaging camera, by means of which the arriving raw dough products being able to be measured in a computer-assisted manner.

3. The apparatus for stretching and/or aligning raw dough products according to claim 2, wherein the temperature of the dough of the raw dough products is determined at the same time as the measurement of the arriving raw dough products.

4. The apparatus for stretching and/or aligning raw dough products according to claim 1, wherein by measuring the arriving raw dough products, the difference in length between the two U branches of the raw dough product are determined by measuring the arriving raw dough products, half thereof representing the extent of the alignment of the raw dough product.

5. The apparatus for stretching and/or aligning raw dough products according to claim 1, wherein by measurement of the overall length of arriving raw dough products and comparing the detected length of each raw dough product to the desired length thereof, it is determined whether the dough is required to be stretched and, if so, to what extent, the difference between the desired length and the actual detected length of the strand of dough defining the extent of stretching of the strand of dough.

6. The apparatus for stretching and/or aligning raw dough products according to claim 1, wherein using the position of each raw dough product at the moment of detection and the known conveyor belt speed, the time at which the raw dough product comes into contact with the means for stretching and/or aligning is determined, so that at this time the process for stretching and/or aligning begins immediately.

7. The apparatus for stretching and/or aligning raw dough products according to claim 1, wherein the detected strand of the raw dough products is transmitted to a dough shaping unit arranged upstream of the device for stretching and/or aligning raw dough products, and wherein the length of the raw dough products that are produced is adjusted to a desired value, whereby when the detected length is greater than the desired length, shorter raw dough products are produced in the dough shaping unit.

8. The apparatus for stretching and/or aligning raw dough products according to claim 2, wherein by measuring the arriving raw dough products, the difference in length between the two U branches of the raw dough product are determined by measuring the arriving raw dough products, half thereof representing the extent of the alignment of the raw dough product.

9. The apparatus for stretching and/or aligning raw dough products according to claim 2, wherein by measurement of the overall length of arriving raw dough products and comparing the detected length of each raw dough product to the desired length thereof, it is determined whether the dough is required to be stretched and, if so, to what extent, the difference between the desired length and the actual detected length of the strand of dough defining the extent of stretching of the strand of dough.

10. The apparatus for stretching and/or aligning raw dough products according to claim 2, wherein using the position of each raw dough product at the moment of detection and the known conveyor belt speed, the time at which the raw dough product comes into contact with the means for stretching and/or aligning is determined, so that at this time the process for stretching and/or aligning begins immediately.

11. The apparatus for stretching and/or aligning raw dough products according to claim 2, wherein the detected strand of the raw dough products is transmitted to a dough shaping unit arranged upstream of the device for stretching and/or aligning raw dough products, and wherein the length of the raw dough products that are produced is adjusted to a desired value, whereby when the detected length is greater than the desired length, shorter raw dough products are produced in the dough shaping unit.
